(19) United States
(12) Patent Application Publication
(10) Pub. No.: US 2003/0121864 A1
(43) Pub. Date: Jul. 3, 2003

(54) System and method for removing deep sub-micron particles from water

(75) Inventors: Kon-Tsu Kin, Hsinchu (TW); Hong-Shiang Tang, Hsinchu (TW)

Correspondence Address: BACON & THOMAS, PLLC, 625 SLATERS LANE, FOURTH FLOOR, ALEXANDRIA, VA, 22314

(73) Assignee: Industrial Technology Research Institute, Hsinchu (TW)

(21) Appl. No.: 10/310,875

(22) Filed: Dec. 6, 2002

(30) Foreign Application Priority Data
Dec. 21, 2001 (TW) 90131953

(51) Int. Cl. B01D 21/00

(52) U.S. Cl. 210/724; 210/723; 210/749; 210/758; 210/759; 210/800; 210/804; 210/806; 210/194; 210/195.1; 210/200; 210/252; 210/295

(57) ABSTRACT

The present invention discloses a process and an apparatus for removing deep sub-micron particles from water. The invented process includes adjusting pH value and conductivity, adding an oxidation agent, performing an electro coagulation reaction/an electro-oxidation reaction, and performing a flocculation sedimentation, etc. The invented apparatus includes a front adjustment tank for adjusting the properties of waste water, wherein the adjustment includes a pH adjustment, an electrolyte adjustment, or an oxidant addition, etc.; an electrocoagulation reaction tank receiving water from the front adjustment tank and having pairs of separated electrodes, one of the electrodes being made of iron; a rear adjustment tank for adjusting pH value of the effluent of the electrocoagulation reaction tank; and a sedimentation reservoir for providing the resulting pH-adjusted, sedimentary floccule-containing water from the rear adjustment tank with a sufficient residence time in said sedimentation reservoir, so that floccules and sedimentation are formed therein.

### FIELD OF THE INVENTION

The present invention relates to a process and a device for removing deep sub-micron particles from water, particularly the removal of deep sub-micro particles in waste water discharged from the chemical mechanical polishing, grinding and dicing saw of wafers in the semiconductor fabrication and encapsulation processes.

### BACKGROUND OF THE INVENTION

Along with the trend of highly integration and miniaturization of line width in the semiconductor, the influence on the mass production of wafers caused by the micro-pollutions of metals, micro particles and organic compounds in the ultra-pure water also increases dramatically. Therefore, “how to remove micro-pollutions” will be a key issue in elevating the production level of the next generation chips. In the removal of micro particles, the size of the micro particles concerned has decreased from the micron level to the deep sub-micron level. Therefore, the technology of removing deep sub-micron particles from water has become one of the bottleneck technologies in producing a next generation high integration semiconductor chips.

Moreover, the importance of removing deep sub-micron particles in water in the recovery of waste water from the semiconductor industry is gradually becoming more significant. Due to the mass production of wafers in recent years, a large amount of waste water is produced and contains a high concentration of deep sub-micron particles, which is difficult to be treated, during grinding and dicing saw prior to the encapsulation operation of the chips. The similar situation has occurred in the semiconductor device fabrication industry. A large amount of waste water containing deep sub-micron particles is also generated due to the introduction of chemical mechanical polishing (CMP). Statistic data shows that in 1998, the CMP processes produced about 225 million gallons of waste water contaminated by deep sub-micron particles. Based on estimation, after 2000, the water consumption by the CMP processes will be 30% to 40% of the total water consumption by the semiconductor device fabrication industry, and the amount of waste water is expected to exceed 450 million gallons in 2006.

The conventional methods in separating particles from water include the chemical coagulation and flocculation methods by chemical mechanisms, and the distillation and membrane filtration methods by physical mechanisms. While applied on the removal of deep sub-micron particles, the former methods require the use of a large amount of coagulants and flocculants to achieve the desired results, generating a relatively large amount of sludge, and the amount of water recovered can only reach about 60%. The latter methods generally can obtain a high percentage and a high quality of water recovery. However, a distillation method requires a massive energy consumption, which is not practically acceptable to the industry; and a membrane filtration method often faces the problems of membrane fouling and low production of water per membrane unit area.

Based on the experiences over the years on the production of ultra-pure water and the recovery of waste water for the semiconductor industry, as well as on the understandings of the properties of the waste water from chemical mechanical polishing, the inventors of the present invention will disclose in the following an electrocoagulation module, which combines electrocoagulation and electro-oxidation mechanisms, and can further link to an ultra-filtration module, to effectively and successfully treat the waste water containing a large amount of deep sub-micron particles discharged from a semiconductor device fabrication and encapsulation processes.

The following table compares the present invention with prior arts regarding the functions, means and results of the treatment:

| | | | | Differences with the |
|---|---|---|---|---|
| U.S. Pat. No. | Time | Inventor | Description of the patent | present invention |
| 5,879,546 | 1999 | Borford | A continuously operated | The present invention |
| | | | water purification and | uses an |
| | | | recovery system uses a | electrocoagulation and |
| | | | unit similar to | ultra-filtration process |
| | | | electrocoagulation to | to treat the waste water |
| | | | coagulate micro particles | containing deep |
| | | | in water, and subsequently | sub-micron particles, |
| | | | uses a filtration bed of | and has a simpler |
| | | | activated carbon to | process. Furthermore, an |
| | | | remove the particles. | electro-oxidation |
| | | | | mechanism is added into |
| | | | | the electrocoagulation |
| | | | | module to further |
| | | | | increase the treatment |
| | | | | efficiency. |
| 5,928,493 | 1999 | Morkovsky | The patent relates to a | The objective of the |
| | | et al. | process and a device for | present invention is to |
| | | | the treatment of industrial | treat deep sub-micron |
| | | | waste water using | particles which basically |
| | | | electrocoagulation to | is different from the |
| | | | achieve the objective of | prior art patent in the |
| | | | removing heavy metals, | process design. |
| | | | dyes, oils, fats, solvents, | |
| | | | and salts, etc. from water. | |
| 5,965,027 | 1999 | Allen et al. | A process for removing | The present invention |
| | | | silica from waste water | uses an |
| | | | comprises using a | electrocoagulation |
| | | | chemical coagulant to | module together with an |
| | | | agglomerate silica | ultrafiltration module |
| | | | particles in water into | without the use of any |
| | | | clusters, and using a | chemical coagulant, and |
| | | | membrane filtration (MF) | has a better result in the |
| | | | unit having a pore size of | treatment of deep |
| | | | 0.5˜5 μm. | sub-micron particles. |
| 6,139,710 | 2000 | Powell | The patent relates to an | The present invention |
| | | | electrocoagulation device, | adds H₂O₂ into the |
| | | | which comprises a | electrocoagulation |
| | | | reaction chamber formed | module so that an |
| | | | of a plurality of vertical | electro oxidation |
| | | | plate electrodes. The | reaction is carried out |
| | | | device is applied with a | during the |
| | | | high voltage to discharge | electrocoagulation |
| | | | a high concentration of | process. This has an |
| | | | metal ions so that the | effect of destroying the |
| | | | waste water passing | stability of the deep |
| | | | through the reaction | sub-micron particles in |
| | | | chamber forms a | the waste water and |
| | | | coagulation during its | increasing the efficiency |
| | | | vertically upward flow. | of removal. |
| | | | The coagulation captures | |
| | | | particles in the water to | |
| | | | form flocculation which is | |
| | | | removed by precipitation. | |
| 6,203,705 | 2001 | James et | A process for treating | The present invention |
| B1 | | at. | CMP waste water uses a | uses an |
| | | | chemical coagulation | electrocoagulation to |
| | | | method to add a coagulant | generate a coagulation |
| | | | and a polymer to form a | effect without the use of |
| | | | flocculation. After | a chemical coagulant in |
| | | | forming large particles, | a order to avoid an |
| | | | MF is used to remove the | adverse effect on the |
| | | | particles. An activated | quality of the recycled |
| | | | carbon bed is used to | water. |
| | | | remove the organic | |
| | | | materials in water and an | |
| | | | ion exchange resin is used | |
| | | | to remove copper ions. | |

### SUMMARY OF THE INVENTION

A primary objective of the present invention is to provide a process and an apparatus for removing deep sub-micron particles from water by combining electrocoagulation and electro-oxidation mechanisms. The present invention can be applied to the treatment and recovery of waste water containing deep sub-micron particles, e.g. waste water discharged from a semiconductor production and encapsulation process.

A module constructed according to the present invention for removing deep sub-micron particles from water comprises:

a front adjustment tank for adjusting the properties of waste water, wherein the adjustment of the properties of the waste water includes (but not limited to) a pH adjustment, an electrolyte adjustment, or an oxidant addition, etc.;

an electrocoagulation reaction tank receiving an effluent from the front adjustment tank for performing electrocoagulation and electro-oxidation reactions in the tank;

a rear adjustment tank for adjusting pH value of an effluent of said electrocoagulation reaction tank; and

a sedimentation reservoir for providing the resulting pH-adjusted, sedimentary floccule-containing water from said rear adjustment tank with a sufficient residence time in said sedimentation reservoir, so that floccules and sedimentation are formed therein.

Preferably, the module of the present invention further comprises an air injector for providing a sufficient mixing between the effluent from said front adjustment tank and air prior to said effluent entering said electrocoagulation reaction tank.

Preferably, the module of the present invention further comprises a recycling mechanism, which comprises a recycling pipeline for recycling a portion of the effluent of said electrocoagulation reaction tank to merge with the effluent of said front adjustment tank; an outflow pipeline for discharging the other portion of said effluent of said electrocoagulation reaction tank to said rear adjustment tank; and one or more valves for controlling the flow rate ratio of the recycled portion to the discharged other portion.

Preferably, said recycling mechanism in the invented module comprises a flow control valve located on said outflow pipeline; another flow control valve and a check valve located on said recycling pipeline.

Preferably, the module of the present invention further comprises an addition pump for adding a H₂O₂ solution to said front adjustment tank, said electrocoagulation tank, or said recycling pipeline.

Preferably, said sedimentation reservoir of the module according to the present invention comprises an overflow trough with an adjustable height for adjusting the residence time.

Preferably, the module of the present invention further comprises one or more auxiliary electrocoagulation reaction tanks connected in series or in parallel to said electrocoagulation reaction tank.

The present invention also discloses a system for removing deep sub-micron particles from water, which comprises the abovementioned module of the present invention and one or more auxiliary purification components connected in series. Said auxiliary purification components are a membrane processing component, an ion exchange component, an activated carbon adsorption component, a degassing component, a filtration component, or an ultra-filtration membrane component, for further purifying an effluent from a previous stage thereof.

The present invention also discloses a system for removing deep sub-micron particles from water, which comprises a plurality of the abovementioned modules of the present invention connected in series and, optionally, one or more auxiliary purification components connected in series between two adjacent modules. Said auxiliary purification components are a membrane processing component, an ion exchange component, an activated carbon adsorption component, a degassing component, a filtration component, or an ultra-filtration membrane component, for further purifying the effluent from a previous stage thereof.

The present invention also discloses a method for removing deep sub-micron particles from water, which comprises the following steps:

(a) adjusting conductivity of a to-be-treated water 0.01˜1 ms/cm, and adding an aqueous solution of H₂O₂with a concentration of 5-50% in a volume ratio of said to-be-treated water : H₂O₂ aqueous solution=1: 0.001˜1: 0.010;

(b) flowing the resulting water from Step (a) through an electrocoagulation reaction tank while controlling an operation current of electrocoagulation at 1˜30 A;

(c) adjusting pH value of an effluent from Step (b) to 4˜6.8; and

(d) applying a sedimentation, centrifugation and/or filtration treatments on the adjusted water from Step (c) to remove deep sub-micron particles from the adjusted water.

Preferably, the concentration of H₂O₂ in Step (a) is 35% or H₂O₂ is replaced by an equivalent oxidation agent.

Preferably, Step (d) of the method according to the present invention comprises sedimentation, pre-filtration, and ultra-filtration membrane filtration treatments.

Preferably, Step (b) of the method according to the present invention further comprises recycling a portion of an effluent from said electrocoagulation reaction tank to said electrocoagulation reaction tank.

Preferably, the method according to the present invention further comprises mixing the resulting water from Step (a) with air to form a gas-liquid mixture before performing Step (b).

Preferably, in Step (b) of the method according to the present invention, a residence time of the resulting water from Step (a) in said electrocoagulation reaction tank is 1˜30 minutes.

### BRIEF DESCRIPTION OF THE DRAWING

FIG. 1 is a schematic block diagram of a preferred embodiment of a module for removing deep sub-micron particles from waste water according to the present invention, wherein 1 . . . front adjustment tank 2 . . . acid/alkali addition pump 3 . . . electrolyte addition pump 4 . . . hydrogen peroxide addition pump 5 . . . mixer 7 . . . air injector 8 . . . electrocoagulation reaction tank 9 . . . check valve 10 . . . recycling pipeline 11 . . . rear adjustment tank 12 . . . acid/alkali addition pump 13 . . . sedimentation reservoir 14 . . . front filter 15,20 . . . temporary storage tank 6,16,21 . . . pump 17 . . . ultra-filtration membrane pipe 18 . . . control valve 19 . . . by-pass valve

### DETAILED DESCRIPTION OF THE INVENTION

The removal of deep sub-micron particles from water according to the present invention uses a new technology where an oxidation agent such as H₂O₂ is added into an electrocoagulation reaction tank so that the oxidation decomposition of an organic dispersing agent is carried out concurrently to the electrocoagulation reaction. The slurry composition used by the chemical mechanical polishing, grinding of wafer surface, and dicing saw operations in a semiconductor production and encapsulation process often contains such an organic dispersing agent. Such an organic dispersing agent is one of the major reasons of the difficulties in removing deep sub-micron particles from the process waste water. The present invention uses a double mechanism of a combination of electrocoagulation and electro oxidation to enable deep sub-micron particles forming large particles of flocculation which are precipitated by gravity, and uses a rear treatment step together with an ultra-filtration module, etc. to achieve the removal of deep sub-micron particles from water.

A waste water containing deep sub-micron particles can be re-generated into pure water free of deep sub-micron particles by the abovementioned steps and process. A lot of the waste water containing deep sub-micron particles from industrial processes can be recycled by a process and a device for removing deep sub-micron particles from water according to the present invention.

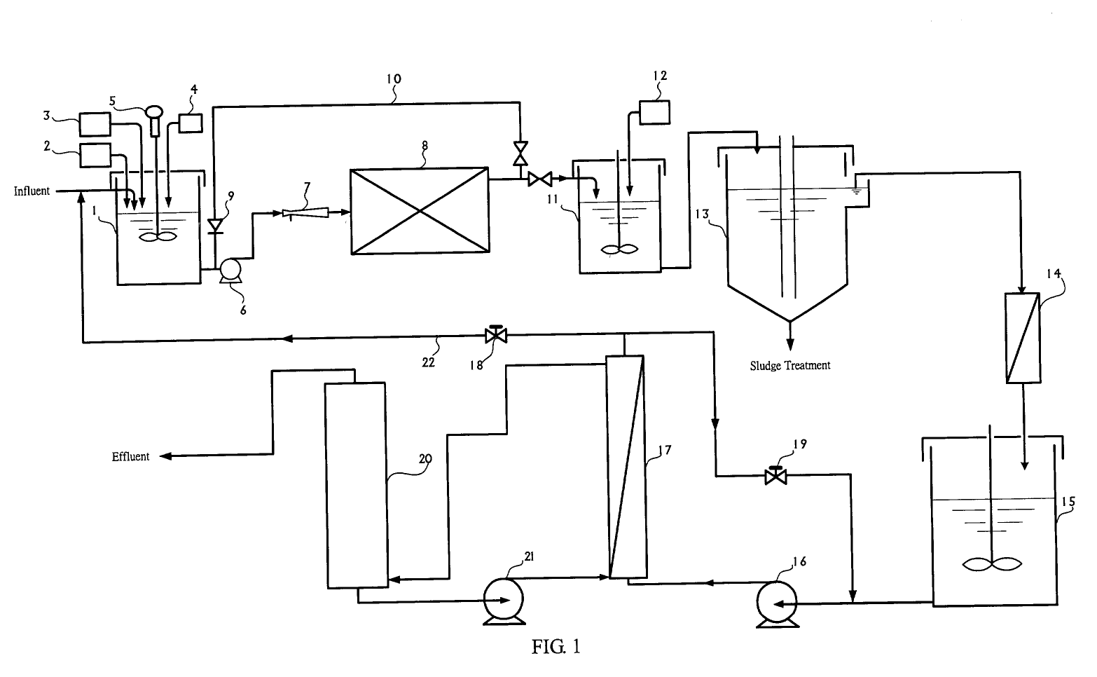

A preferred embodiment of a module for removing deep sub-micron particles from waste water according to the present invention is shown in FIG. 1, wherein the front adjustment tank 1 comprises a tank body, a pH meter, a conductivity meter, an acid/alkali addition pump 2, an electrolyte addition pump 3, a H₂O₂ addition pump 4, and a mixer 5. After a waste water enters said tank body, the quality of water will be automatically monitored and adjusted to a conductivity of 0.01˜1 ms/cm. H₂O₂ aqueous solution with a concentration of 35% is added into water at a volume ratio of 1:0.001˜0.01 (water : H₂O₂ aqueous solution). A pump 6 pressurizes and transports water from the front adjustment tank 1 and a recycling pipeline 10 to an air injector 7 which sucks air in and mixes the air with water for keeping the surface of the electrode clean during the electrocoagulation process and maintaining the released iron ions at a right configuration. The water stream, after mixed by the air injector, enters an electrocoagulation reaction tank 8, which comprises plural pairs of cathode/anode therein, the material of which being stainless or iron. After the power to the electrocoagulation reaction tank has been turned on, the surface of the iron electrode releases ferrous ions which undergo an electro oxidation reaction with H₂O₂ added in the previous adjustment tank while being converted into ferric hydroxide floccules to catch deep sub-micron particles from water. A recycling pipeline 10 is installed on the effluent pipeline on the rear section of the electrocoagulation reaction tank to recycle a portion of the water after the electrocoagulation process to the front end of the pump 6 to be mixed with the un-treated waste water so as to increase the oxidation time required by the organic dispersing agent in water and achieve a sufficient concentration of iron ions. A check valve 9 is installed on the recycling pipeline 10 to prevent the waste water from entering the recycling pipeline. A majority of the effluent after the electrocoagulation treatment enters the rear adjustment tank 11. An acid/alkali addition pump 12 is used to adjust the pH value of the treated water after the electrocoagulation reaction to 4˜6.8 for the formation of floccule so that the floccule can maintain a good sedimentation property after the water enters the sedimentation reservoir 13. The sedimentation reservoir is designed to have a residence time of 1˜3 hours to provide a sufficient sedimentation time for the floccules formed by deep sub-micron particles. A small portion of the floccules, through an overflow opening, enters a 150 μm pre-filter, and enters a temporary storage tank 15 of an ultra-filtration module for avoiding the occurrence of blockage of the ultra-filtration membrane. A pump 16 pressurizes and transports the water in the temporary storage tank to an ultra-filtration membrane pipe 17. The filtration flow and pressure are controlled at a suitable operation range by adjusting the pump 16, the pressure control valve 18, and the by-pass valve 19, in order to avoid the occurrence of a blockage on the membrane pipe and maintain a suitable flow of filtered water. A portion of the filtered water is stored in a temporary storage tank 20, which is connected to a pump 21, to be used in a reverse-cleaning process on the membrane. The rest of the effluent can be recycled to the process for reuse. The concentrated liquid retained by the membrane pipe, through a pipeline 22, is guided back to the front adjustment tank 1 for performing an identical processing procedure.

### EXAMPLE 1

A module as shown in FIG. 1 was used to carry out an experiment on removing deep sub-micron particles from a CMP waste water containing about 0.2% of deep sub-micron particles.

The front adjustment tank adjusted the pH value of the waste water to 4 and the conductivity to 0.5 ms/cm. H₂O₂ was added into the waste water at a ratio of 1:0.005 (water : H₂O₂ aqueous solution). The current in the electrocoagulation reaction tank was controlled at 1 A. The recycled flow and the effluent were controlled so that the residence time of the waste water in the electrocoagulation reaction tank was maintained at 15 minutes. The rear adjustment tank adjusted the pH value of the effluent from the electrocoagulation reaction tank from 8.8 to 4.5. The residence time of the sedimentation reservoir was set to be 3 hours. After the abovementioned steps, the effluent contained 0.003% of deep sub-micron particles, and had a removal rate of 98.5%. The effluent was processed by an ultra-filtration module operated at a filtration rate of 2 m/sec, a pressure difference of 25 psi. The filtered water flow was 18.7 liter/minute. The filtrate measured contained no deep sub-micron particles. The removal rate in the entire process was 100%.

1. A module for removing deep sub-micron particles from water comprising:
a front adjustment tank for adjusting the properties of waste water, wherein the adjustment of the properties comprises a pH adjustment, an electrolyte adjustment, or an oxidant addition;
an electrocoagulation reaction tank receiving an effluent from the front adjustment tank for performing electrocoagulation and electro-oxidation reactions in said tank;
a rear adjustment tank for adjusting pH value of an effluent of said electrocoagulation reaction tank; and
a sedimentation reservoir for providing the resulting pH-adjusted, sedimentary floccule-containing water from said rear adjustment tank with a sufficient residence time in said sedimentation reservoir, so that floccules and sedimentation are formed therein.

2. The module as claimed in claim 1 further comprising an air injector for providing a sufficient mixing between the effluent from said front adjustment tank and air prior to said effluent from said front adjustment tank entering said electrocoagulation reaction tank.

3. The module as claimed in claim 1 further comprising a recycling mechanism comprising a recycling pipeline for recycling a portion of the effluent from said electrocoagulation reaction tank to merge with the effluent from said front adjustment tank; an outflow pipeline for discharging the other portion of said effluent from said electrocoagulation reaction tank to said rear adjustment tank; and one or more valves for controlling the flow rate ratio of the recycled portion to the discharged other portion.

4. The module as claimed in claim 3, wherein said recycling mechanism in the invented module comprises a flow control valve located on said outflow pipeline; another flow control valve and a check valve located on said recycling pipeline.

5. The module as claimed in claim 3 further comprising an addition pump for adding a H₂O₂ solution to said front adjustment tank, said electrocoagulation tank, or said recycling pipeline.

6. The module as claimed in claim 1, wherein said sedimentation reservoir of the module according to the present invention comprises an overflow trough with an adjustable height for adjusting the residence time.

7. The module as claimed in claim 1 further comprising one or more auxiliary electrocoagulation reaction tanks connected in series or in parallel to said electrocoagulation reaction tank.

8. A system for removing deep sub-micron particles from water, which comprises the module as defined in claim 1 and one or more auxiliary purification components connected in series, wherein said one or more auxiliary purification components independently are a membrane processing component, an ion exchange component, an activated carbon adsorption component, a degassing component, a filtration component, or an ultra-filtration membrane component, for further purifying an effluent from a previous stage thereof.

9. A system for removing deep sub-micron particles from water, which comprises a plurality of modules as defined in claim 1 and connected in series and, optionally, one or more auxiliary purification components connected in series between two adjacent modules of said plurality of modules, wherein said one or more auxiliary purification components independently are a membrane processing component, an ion exchange component, an activated carbon adsorption component, a degassing component, a filtration component, or an ultra-filtration membrane component, for further purifying an effluent from a previous stage thereof.

10. A method for removing deep sub-micron particles from water comprising the following steps:
(a) adjusting conductivity of a to-be-treated water to 0.01˜1 ms/cm, and adding an aqueous solution of H₂O₂with a concentration of 5-50% in a volume ratio of said to-be-treated water : H₂O₂ aqueous solution=1:0.001˜1:0.010 or an equivalent oxidation agent to said to-be-treated water;
(b) flowing the resulting water from Step (a) through an electrocoagulation reaction tank while controlling an operation current of electrocoagulation at 1˜30 A;
(c) adjusting pH value of an effluent from Step (b) to 4˜6.8; and
(d) applying a sedimentation, centrifugation and/or filtration treatments on the adjusted water from Step (c) to remove deep sub-micron particles from the adjusted water.

11. The method as claimed in claim 10, wherein H₂O₂ aqueous solution is added in Step (a).

12. The method as claimed in claim 10, wherein treatments applied in Step (d) comprise said sedimentation, pre-filtration, and ultra-filtration membrane filtration treatments.

13. The method as claimed in claim 10 further comprising recycling a portion of an effluent from said electrocoagulation reaction tank to said electrocoagulation reaction tank in Step (b).

14. The method as claimed in claim 10 further comprising mixing the resulting water from Step (a) with air to form a gas-liquid mixture before performing Step (b).

15. The method as claimed in claim 10, wherein a residence time of the resulting water from Step (a) in said electrocoagulation reaction tank is 1˜30 minutes.
